(19) United States
(12) Patent Application Publication
(10) Pub. No.: US 2019/0099801 A1
(43) Pub. Date: Apr. 4, 2019

(54) METHOD OF JOINING BELT MATERIALS

(71) Applicant: HONDA MOTOR CO., LTD., Tokyo (JP)

(72) Inventors: Masaaki Fujita, Tochigi-ken (JP); Ugeun Shin, Tochigi-ken (JP); Hiroshi Matsui, Tochigi-ken (JP); Kazuma Fujiwara, Tochigi-ken (JP); Kuniaki Akutsu, Tochigi-ken (JP)

(21) Appl. No.: 16/142,039

(22) Filed: Sep. 26, 2018

(30) Foreign Application Priority Data
Sep. 29, 2017 (JP) 2017-189282

(51) Int. Cl. B21D 53/14; B23P 11/00; B21C 47/16

(52) U.S. Cl. CPC B21D 53/14; B21C 47/16; B23P 11/00

(57) ABSTRACT

A first recessing-and-projecting line is formed in a trailing end of a preceding first belt material and a second recessing-and-projecting line is formed in a leading end of a newly fed out second belt material, and the first recessing-and-projecting line and the second recessing-and-projecting line are fitted to each other, thereby joining the first belt material and the second belt material. Note that the first recessing-and-projecting line and the second recessing-and-projecting line pass through a holding section that holds an element in the first belt material or the second belt material.

### CROSS-REFERENCE TO RELATED APPLICATION

This application is based upon and claims the benefit of priority from Japanese Patent Application No. 2017-189282 filed on Sep. 29, 2017, the contents of which are incorporated herein by reference.

### BACKGROUND OF THE INVENTION

### Field of the Invention

The present invention relates to a method of joining belt materials in which, in order to punch an element, a first belt material fed out ahead and a second belt material fed out following said first belt material are joined to configure a joined material.

### Description of the Related Art

In a continuously variable transmission (CVT) installed in an automobile, a metal belt runs in a circulating manner between a drive shaft pulley and a driven shaft pulley. This metal belt is configured by a plurality of elements being engaged in two metal ring laminated bodies.

This kind of element is obtained by successively feeding out to a press apparatus long belt materials made of a metal, and performing a punching processing on the belt materials with said press apparatus. Note that the element is not separated from the belt material in one step, but goes through a window forming processing and a crushing processing, and furthermore, as described in Japanese Laid-Open Patent Publication No. 2001-232424, goes through a rough punching processing in which a holding section joined to the belt material is left in part of the element, and a completion punching processing (separating processing) in which the holding section is severed to separate the element from the belt material, whereby the element is formed and separated.

### SUMMARY OF THE INVENTION

The belt materials are fed out intermittently to a press molding apparatus by a feeding apparatus (feeder). This feeder is arranged more to an upstream side in a feeding-out direction than the press molding apparatus is. Therefore, after a trailing end of the belt material has passed through the feeder, the belt material cannot be fed to the press molding apparatus. Note that in the window forming step and crushing step, bumps or depressions are formed in a surface of a region that will be the element. If the feeder is arranged more to a downstream side than the press molding apparatus is, then a feeding-out speed of the belt materials varies due to the bumps or depressions, so it becomes difficult for the belt materials to be fed out at constant intervals.

For the above kinds of reasons, the element cannot be punched from a section from the feeder to the rough punching step, of the belt material. That is, this section has to be discarded, and yield deteriorates, hence manufacturing costs increase.

Moreover, arrangements for extracting the belt material from the press molding apparatus and setting in the feeder a new belt material that should be next fed out, are required. A long time being required to replace the belt material at this time is also one reason for manufacturing costs increasing.

A main object of the present invention is to provide a method of joining belt materials by which it is easy for a first belt material fed out ahead and a second belt material fed out following said first belt material, to be joined.

Another object of the present invention is to provide a method of joining belt materials that enables elements to be continuously manufactured.

According to one embodiment of the present invention, there is provided a method of joining belt materials including:

a joining step in which a trailing end of a first belt material which is fed out ahead and a leading end of a second belt material which is fed out after the first belt material, are opposed, and a first recessing-and-projecting line is formed in the trailing end of the first belt material while a second recessing-and-projecting line is formed in the leading end of the second belt material, and then the first recessing-and-projecting line and the second recessing-and-projecting line are fitted to each other thereby joining the first belt material and the second belt material; and

a punching step in which the first belt material and the second belt material are fed out and punched in a shape of an element of a belt for continuously variable transmission,

in the joining step, the first recessing-and-projecting line and the second recessing-and-projecting line being formed in a position that passes through a holding section holding the element in the first belt material or the second belt material, thereby joining the first belt material and the second belt material.

Thus, in the present invention, a configuration is adopted whereby the first recessing-and-projecting line is formed in the first belt material and the second recessing-and-projecting line is formed in the second belt material, and these first recessing-and-projecting line and second recessing-and-projecting line are engaged with (fitted to) each other. Therefore, the second belt material can be fed out integrally with the first belt material, while it is avoided that the second belt material detaches from the first belt material.

In this case, sections-for-discarding will be only a section more to an upstream side in the feeding-out direction than the first recessing-and-projecting line is in the first belt material, and only a section more to a downstream side in the feeding-out direction than the second recessing-and-projecting line is in the second belt material. Hence, a discarded amount of each of the belt materials is reduced. Therefore, lowering of manufacturing costs of the element can be achieved.

Additionally, in the present invention, the first recessing-and-projecting line and the second recessing-and-projecting line are formed in a position passing through the holding section. In this case, it is avoided that in the rough punching processing, part of the element is punched along with an unrequired portion. Therefore, it is prevented that a punched piece falls into a punching die, and work to remove the fallen punched piece (fallen piece) from the punching die becomes unnecessary.

In other words, due to the first recessing-and-projecting line and the second recessing-and-projecting line having been formed in the above-described position, an element of a predetermined shape can be obtained. Therefore, a manufacturing yield of the element improves, so manufacturing costs of the element can be further lowered.

It is preferable that the first recessing-and-projecting line and the second recessing-and-projecting line are formed so as to include at least one pair of a recess and a projection within one item of the element. In this case, a joining strength achieved by the first recessing-and-projecting line and the second recessing-and-projecting line between the first belt material and the second belt material becomes excellent. Therefore, detachment of the second belt material from the first belt material can be effectively prevented. That is, the second belt material can be fed out integrally with the first belt material.

Moreover, it is preferable that notches are formed in a vicinity of the trailing end of the first belt material, and that the first recessing-and-projecting line is formed in a state where engaging members have been engaged in said notches. Since the first belt material has its position fixed by engagement, the first belt material is prevented from undergoing a position slippage. Therefore, it becomes easy for the first recessing-and-projecting line to be formed in a predetermined position of the first belt material.

For similar reasons, it is preferable that notches are formed in a vicinity of the leading end of the second belt material, and that the second recessing-and-projecting line is formed in a state where engaging members have been engaged in said notches. Since the second belt material is prevented from undergoing a position slippage by this engagement, it becomes easy for the second recessing-and-projecting line to be formed in a predetermined position of the second belt material.

Furthermore, it is preferable that first notches are formed in a vicinity of the trailing end of the first belt material and second notches are formed in a vicinity of the leading end of the second belt material, and that fitting of the first recessing-and-projecting line and the second recessing-and-projecting line is performed in a state where engaging members have been engaged in composite notches formed by parts of the first notches and parts of the second notches. In this case, since positioning of the first recessing-and-projecting line of the first belt material and the second recessing-and-projecting line of the second belt material is performed by engagement, it is difficult for relative position slippage of the first recessing-and-projecting line and the second recessing-and-projecting line to occur. Therefore, the first recessing-and-projecting line and the second recessing-and-projecting line can be easily engaged.

According to the present invention, a configuration is adopted whereby the first recessing-and-projecting line formed in the first belt material and the second recessing-and-projecting line formed in the second belt material are fitted to each other, so the second belt material can be fed out integrally with the first belt material, while it is avoided that the second belt material detaches from the first belt material.

Moreover, in this case, only a section more to the upstream side in the feeding-out direction than the first recessing-and-projecting line is in the first belt material and only a section further to the downstream side in the feeding-out direction than the second recessing-and-projecting line is in the second belt material, will be sections-for-discarding. Therefore, the discarded amount of each of the belt materials is reduced.

Additionally, in the present invention, the first recessing-and-projecting line and the second recessing-and-projecting line are formed in a position passing through the holding section. Therefore, it is possible for the element to be obtained as a predetermined shape. That is, the manufacturing yield of the element improves. For the above kinds of reasons, a lowering of manufacturing costs of the element can be achieved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic overall front view of an element for a continuously variable transmission;

FIG. 2 is an enlarged perspective partial cross-sectional view of essential parts of a metal belt of a continuously variable transmission configured including the element of FIG. 1;

FIG. 3 is a schematic system drawing of an element manufacturing facility for obtaining the element from a roll material;

FIG. 4 is a schematic plan view of essential parts showing a state where first notches have been formed in a first strip (a first belt material);

FIG. 5 is a schematic plan view of essential parts showing a state, following from FIG. 4, where a first recessing-and-projecting line has been formed in the first strip;

FIG. 6 is a schematic plan view of essential parts showing a state, following from FIG. 5, where second notches have been formed in a vicinity of a leading end section of a second strip (a second belt material) while a trailing end where the first recessing-and-projecting line has been formed is fed out to a die for fitting;

FIG. 7 is a schematic plan view of essential parts showing a state, following from FIG. 6, where a second recessing-and-projecting line has been formed in the second strip;

FIG. 8 is a schematic plan view of essential parts showing a state, following from FIG. 7, where the first strip and the second strip have been joined via the first recessing-and-projecting line and the second recessing-and-projecting line;

FIG. 9 is a schematic plan view of essential parts showing one example of a positional relationship of the first recessing-and-projecting line and second recessing-and-projecting line, and a holding section that holds the element in the strip;

FIG. 10 is a schematic plan view of essential parts showing another example of a positional relationship of the first recessing-and-projecting line and second recessing-and-projecting line, and the holding section; and

FIG. 11 is a schematic side view of essential parts showing a state of the first strip and the second strip being joined in a strip joining apparatus different from that of FIGS. 4 to 8.

### DESCRIPTION OF THE PREFERRED EMBODIMENTS

A preferred embodiment of a method of joining belt materials according to the present invention will be presented and described in detail below with reference to the accompanying drawings, in relation to manufacturing steps of an element for a continuously variable transmission. Note that below, “step” is sometimes also rephrased as “processing”.

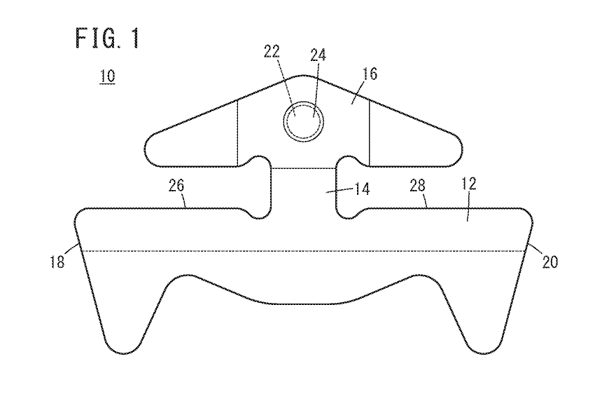

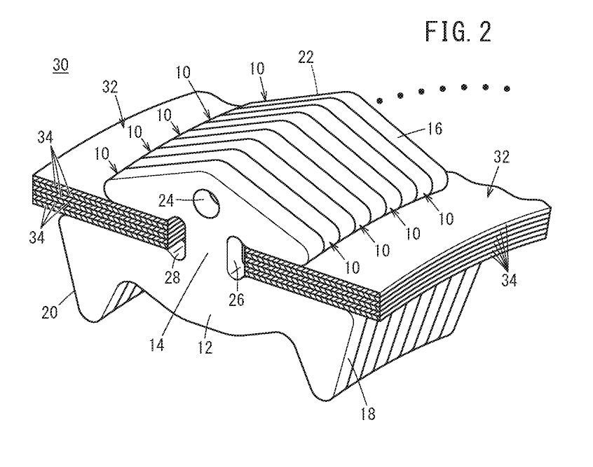

First, the element will be described with reference to FIGS. 1 and 2. This element 10 includes: a body section 12; a neck section 14 formed projecting from substantially a center section in a width direction on an upper edge side of said body section 12; and a head section 16 lying on said neck section 14 and broad compared to said neck section 14.

An unillustrated pulley of a driven shaft makes sliding contact with a left side end edge 18 of the body section 12, while an unillustrated pulley of a drive shaft makes sliding contact with a right side end edge 20 of the body section 12. Note that thickness of a lower half section of the body section 12 gradually decreases as a lower edge of said lower half section is approached. That is, the lower half section of the body section 12 is a thin section.

A circular columnar projection 22 is formed projecting in one end surface of the head section 16, and a recess-for-insertion 24 cut out in a circular columnar body shape is formed in the other end surface of the head section 16 in a position corresponding to a position of the circular columnar projection 22. As will be mentioned later, this recess-for-insertion 24 is engaged by the circular columnar projection 22 of an adjacent element 10.

The neck section 14 is narrower in width compared to the body section 12 and the head section 16. As a result, a left shoulder groove 26 and a right shoulder groove 28 are formed between an upper edge of the body section 12 and a lower edge of the head section 16.

As shown in FIG. 2, the element 10 configured in this way configures a metal belt 30 that is interposed between a pair of pulleys (not illustrated) configuring the continuously variable transmission. That is, said metal belt 30 is configured by respectively engaging two metal ring laminated bodies 32 in the left shoulder groove 26 and right shoulder groove 28 of a plurality of the elements 10, and adjacent elements 10, 10 are joined to each other by the circular columnar projection 22 of one being engaged in the recess-for-insertion 24 of the remaining one. Moreover, as described above, the pulley of the driven shaft (neither of which is illustrated) makes sliding contact with the left side end edge 18 of the body section 12, while the pulley of the drive shaft (neither of which is illustrated) makes sliding contact with the right side end edge 20 of the body section 12.

Note that in FIG. 2, the metal ring laminated body 32 is shown cut in a vicinity of the left shoulder groove 26 and the right shoulder groove 28 of the element 10. Moreover, the metal ring laminated body 32 is configured by laminating a plurality of thin ring bodies 34. That is, the metal ring laminated body 32 is a laminated body configured by sequentially mounting a ring body 34 of large diameter (peripheral length) on an outer peripheral side of a ring body 34 of small diameter (peripheral length).

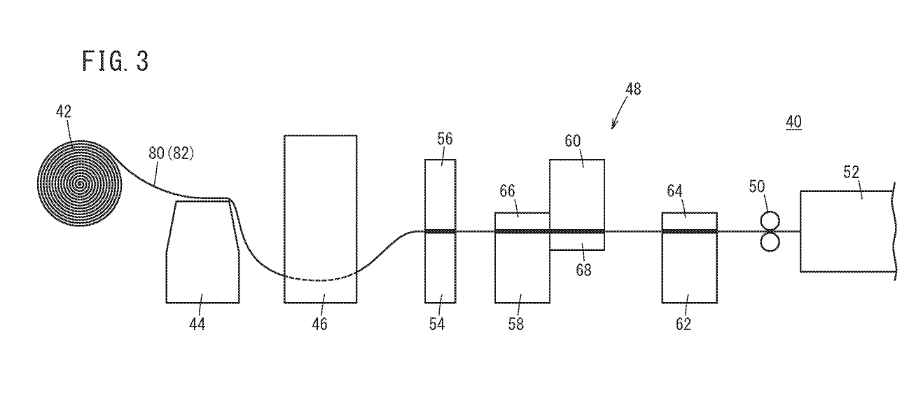

The element 10 is manufactured by an element manufacturing facility 40 an outline of which is shown in FIG. 3. This element manufacturing facility 40 includes: an unillustrated uncoiler in which a roll material 42 is held; a leveler 44 by which the strip (the belt material) that has been drawn out from the roll material 42 is kept at a constant height; a loop table 46 that holds the strip in a bent state; a strip joining apparatus 48; a feeder 50 that intermittently feeds out the strip; and a press molding apparatus 52. The method of joining belt materials according to the present embodiment is carried out by the strip joining apparatus 48.

The strip joining apparatus 48 includes: a notch forming die 54 and notch forming punch 56; a recessing-and-projecting line forming die 58 and recessing-and-projecting line forming punch 60; and a caulking die 62 and caulking punch 64. The dies 54, 58, 62 are each fixed types having their positions fixed, while the punches 56, 60, 64 are each movable types that respectively approach (descend onto) or separate from (rise up from) the dies 54, 58, 62. Moreover, the recessing-and-projecting line forming die 58 is additionally provided with an upper strip-supporting panel 66, and the recessing-and-projecting line forming punch 60 is additionally provided with a lower strip-supporting panel 68. The upper strip-supporting panel 66 is a fixed type, and the lower strip-supporting panel 68 is a movable type that undergoes displacement integrally with the recessing-and-projecting line forming punch 60.

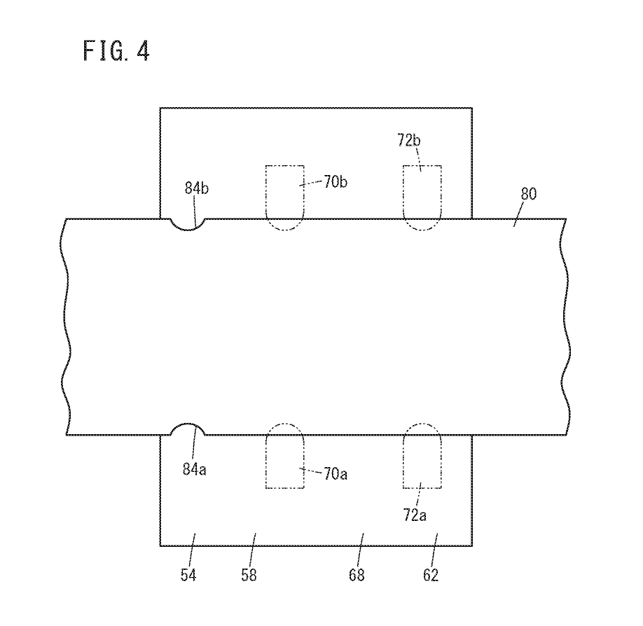

FIG. 4 is a schematic plan view of the strip joining apparatus 48 showing integrally the notch forming die 54, the recessing-and-projecting line forming die 58, the lower strip-supporting panel 68, and the caulking die 62. The recessing-and-projecting line forming die 58 is provided with a pair of first engaging members 70a, 70b, and the caulking die 62 is also similarly provided with a pair of second engaging members 72a, 72b. The first engaging members 70a, 70b and the second engaging members 72a, 72b are arranged in a direction substantially orthogonal to a feeding-out direction (a longitudinal direction) of a first strip 80 as a first belt material and a second strip 82 as a second belt material, that is, in a width direction.

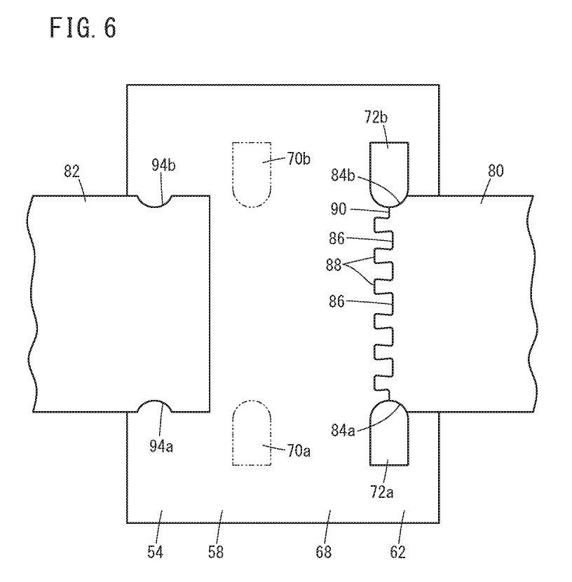

When the roll material 42 is consumed to its trailing end by being sequentially fed out as the first strip 80, a new roll material 42 is mounted in the uncoiler, and a leading end of the new roll material 42 is fed out as the second strip 82. The trailing end of the first strip 80 and the leading end of the second strip 82 (refer to FIG. 6) are joined as follows.

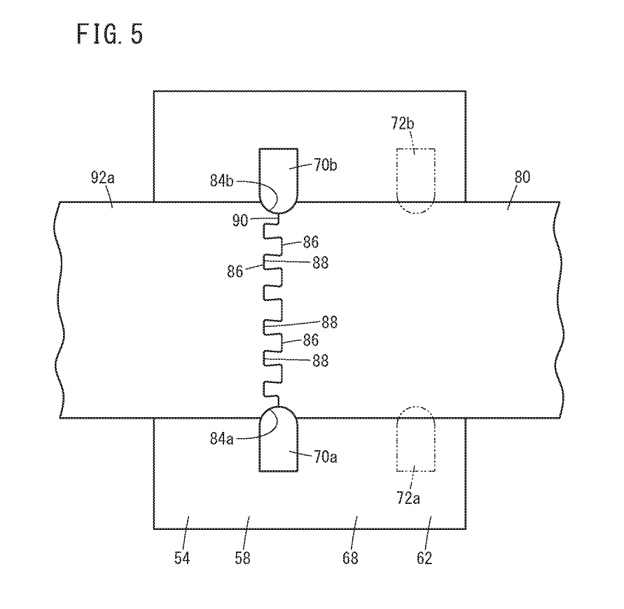

FIG. 4 shows a state where a vicinity of the trailing end of the first strip 80 is positioned between the notch forming die 54 and the notch forming punch 56 (refer to FIG. 3). Note that in reality the first strip 80 is passed along between the recessing-and-projecting line forming die 58 and the upper strip-supporting panel 66, and between the lower strip-supporting panel 68 and the recessing-and-projecting line forming punch 60. However, in order to make the position of the first strip 80 easily understandable in FIG. 4, the drawing is simplified. The same applies also to FIGS. 5 to 8.

When the vicinity of the trailing end of the first strip 80 has been positioned between the notch forming die 54 and the notch forming punch 56, the feeder 50 once stops feeding-out of the first strip 80. Then, the notch forming punch 56 descends, and first notches 84a, 84b of substantially semicircular shape are respectively formed in both end sections in the width direction of the first strip 80.

After the notch forming punch 56 has risen, the feeder 50 feeds out a predetermined section (pitch) amount of the first strip 80. As shown in FIG. 5, this feeding-out results in positions of the first notches 84a, 84b coinciding with positions of the first engaging members 70a, 70b. Therefore, the first notches 84a, 84b engage with the first engaging members 70a, 70b, whereby the vicinity of the trailing end of the first strip 80 has its position fixed.

In this state, the recessing-and-projecting line forming punch 60 descends toward the recessing-and-projecting line forming die 58. As a result, a first recessing-and-projecting line 90 having a plurality of recesses 86 and projections 88 alternately aligned therein is formed in the vicinity of the trailing end of the first strip 80. As the lower strip-supporting panel 68 and the recessing-and-projecting line forming punch 60 further descend, the vicinity of the trailing end of the first strip 80 is divided into a processing target section to be fed out to the press molding apparatus 52 and a section-for-discarding 92a, with the first recessing-and-projecting line 90 as a boundary line.

The first recessing-and-projecting line 90 extends so as to reach from the first notches 84a to the first notches 84b. Therefore, while approximately half of the first notches 84a, 84b are left in the processing target section, the remaining approximately half of the first notches 84a, 84b are removed along with the section-for-discarding 92a.

After the recessing-and-projecting line forming punch 60 has risen, the feeder 50 feeds out a predetermined pitch amount of the first strip 80. Due to this feeding-out, as shown in FIG. 6, positions of the first notches 84a, 84b left in the processing target section correspond to positions of the second engaging members 72a, 72b, and the first notches 84a, 84b engage with the second engaging members 72a, 72b. That is, a vicinity of a trailing end of the processing target section (the first strip 80) has its position fixed. At this time, a position of the first recessing-and-projecting line 90 coincides with a position of the caulking die 62.

After the section-for-discarding 92a has been removed from between the recessing-and-projecting line forming die 58 and the upper strip-supporting panel 66, a vicinity of the leading end of the second strip 82 is positioned between the notch forming die 54 and the notch forming punch 56, under operation of the feeder 50. Then, the notch forming punch 56 descends, and second notches 94a, 94b of substantially semicircular shape are respectively formed in both end sections in the width direction of the second strip 82. The first notches 84a, 84b and the second notches 94a, 94b are formed by the same notch forming punch 56, so have substantially the same shape.

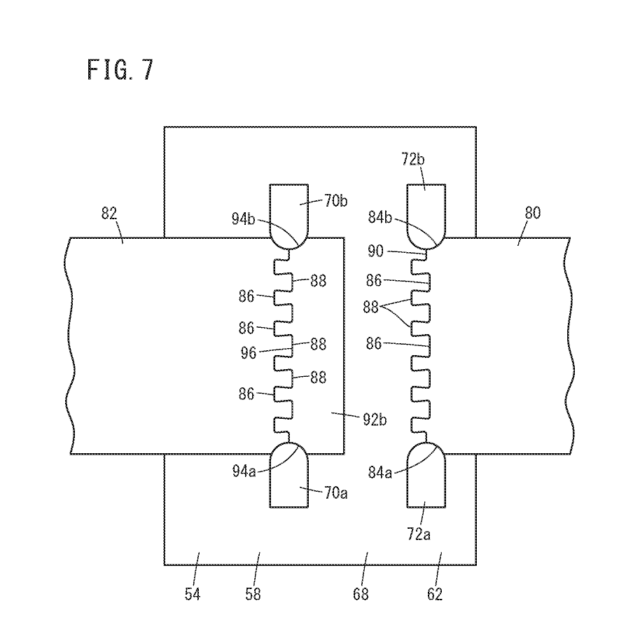

After the notch forming punch 56 has risen, the feeder 50 feeds out the second strip 82 with a predetermined pitch. As a result, as shown in FIG. 7, positions of the second notches 94a, 94b coincide with positions of the first engaging members 70a, 70b. That is, the second notches 94a, 94b engage with the first engaging members 70a, 70b. As a result, the vicinity of the leading end of the second strip 82 has its position fixed.

In this state, the recessing-and-projecting line forming punch 60 descends toward the recessing-and-projecting line forming die 58. As a result, a second recessing-and-projecting line 96 having a plurality of recesses 86 and projections 88 alternately aligned therein is formed in the vicinity of the leading end of the second strip 82. As the lower strip-supporting panel 68 and the recessing-and-projecting line forming punch 60 further descend, the vicinity of the leading end of the second strip 82 is divided into a section-for-discarding 92b which is more to a downstream side than the second recessing-and-projecting line 96 is, and a processing target section which is more to an upstream side than the second recessing-and-projecting line 96 is and which is to be fed out to the press molding apparatus 52.

Thus, in the present embodiment, a configuration is adopted whereby the first notches 84a, 84b and the second notches 94a, 94b are utilized to fix the position of the first strip 80 or the second strip 82, and in this state, the first recessing-and-projecting line 90 and the second recessing-and-projecting line 96 are formed. Therefore, the first recessing-and-projecting line 90 and the second recessing-and-projecting line 96 are formed precisely in predetermined positions of the first strip 80 and the second strip 82.

The second recessing-and-projecting line 96 extends so as to reach from the second notches 94a to the second notches 94b. Therefore, while approximately half on the downstream side of the second notches 94a, 94b is removed along with the section-for-discarding 92b, approximately half of the second notches 94a, 94b are left in the processing target section on the upstream side.

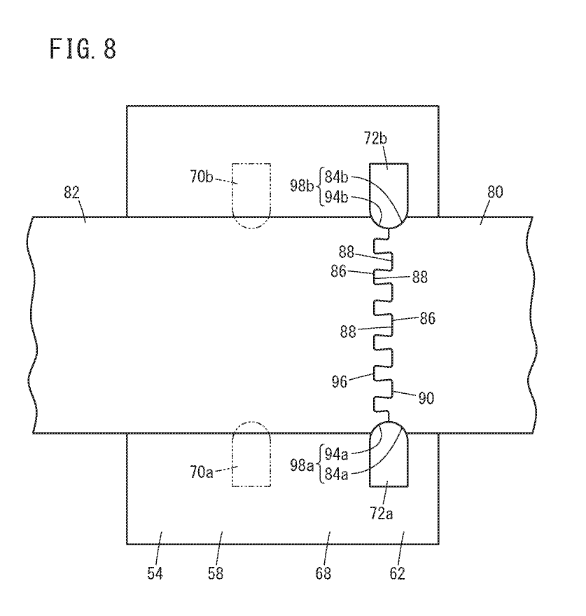

While the second notches 94a, 94b and the second recessing-and-projecting line 96 are being formed in this way, the trailing end of the first strip 80 where the first recessing-and-projecting line 90 has been formed is waiting at the caulking die 62. When the section-for-discarding 92b is removed from between the lower strip-supporting panel 68 and the recessing-and-projecting line forming punch 60, the feeder 50 feeds out to a caulking die 62 side the leading end of the second strip 82 where the second recessing-and-projecting line 96 has been formed, as shown in FIG. 8.

At this time, residual sections of the first notches 84a, 84b on a first strip 80 side and residual sections of the second notches 94a, 94b on a second strip 82 side are combined to form composite notches 98a, 98b, and said composite notches 98a, 98b engage with the second engaging members 72a, 72b. That is, the first strip 80 and the second strip 82 have their positions fixed.

In the first strip 80, a downstream side in the vicinity of the trailing end provided with the first recessing-and-projecting line 90 is left as the processing target section, while in the second strip 82, an upstream side in the vicinity of the leading end provided with the second recessing-and-projecting line 96 is left as the processing target section. Therefore, in the first recessing-and-projecting line 90 and the second recessing-and-projecting line 96, phases of the recesses 86 and projections 88 are reversed. Moreover, the first recessing-and-projecting line 90 and the second recessing-and-projecting line 96 are formed precisely, and the first strip 80 and the second strip 82 have their positions fixed. Therefore, it is difficult for a relative position slippage of the first recessing-and-projecting line 90 and the second recessing-and-projecting line 96 to occur. For the above kinds of reasons, the first recessing-and-projecting line 90 and the second recessing-and-projecting line 96 engage with each other in the caulking die 62.

Next, the caulking punch 64 descends toward the caulking die 62, in other words, toward the engaged first recessing-and-projecting line 90 and second recessing-and-projecting line 96. That is, bodies of the recesses 86 and projections 88 forming the first recessing-and-projecting line 90 and second recessing-and-projecting line 96 are stretched by crushing, and, as a result, the recesses 86 and projections 88 attain a mutually caulked state. Due to this caulking, the first strip 80 and the second strip 82 are joined.

The joined first strip 80 and second strip 82 are integrally fed out to the press molding apparatus 52, and, in said press molding apparatus 52, undergo window forming processing and crushing processing as required. In the crushing processing, crushing for making the lower half section of the body section 12 a thin section, is performed.

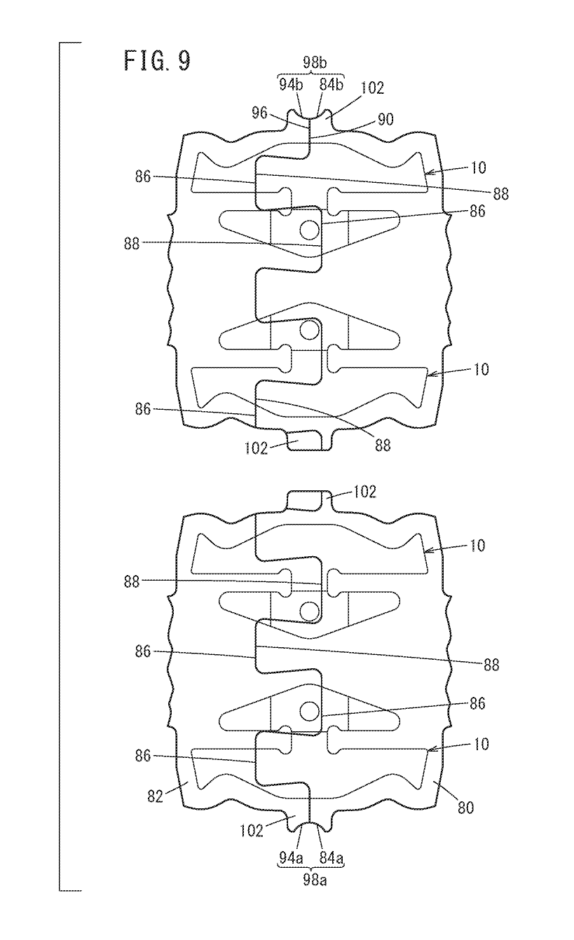

Then, as shown in FIG. 9, there is performed a rough punching processing in which a holding section 102 holding the element 10 in the first strip 80 or the second strip 82 is left. Now, the first recessing-and-projecting line 90 and the second recessing-and-projecting line 96 are formed in a position passing through the holding section 102.

If, in contrast, the first recessing-and-projecting line 90 and the second recessing-and-projecting line 96 are positioned so as to detour the holding section 102, then in the rough punching processing, part of the element 10 is also punched thereby falling into a punching die. That is, by configuring the first recessing-and-projecting line 90 and the second recessing-and-projecting line 96 to be in a position passing through the holding section 102, the element 10 can be kept held in the first strip 80 or the second strip 82 as a predetermined shape. Therefore, a manufacturing yield of the element 10 improves, and work for stopping the press molding apparatus 52 to remove a fallen piece becomes unnecessary.

Specifically, in the present embodiment, the first recessing-and-projecting line 90 and the second recessing-and-projecting line 96 are shaped such that there exists at least one pair of the recess 86 and the projection 88 for one item of the element 10. Since a sufficient caulking force is realized in a joining section for this purpose, then separation of the first strip 80 and the second strip 82 is avoided. That is, it is easy for the second strip 82 to be fed out integrally with the first strip 80.

Then, the first strip 80 and the second strip 82 are further fed out under operation of the feeder 50, and a completion punching processing (a separating processing) to sever the holding section 102 is performed. As a result, the element 10 is separated from the first strip 80 or the second strip 82.

Thus, according to the present embodiment, a configuration is adopted such that when the roll material 42 has reached its trailing end after being fed out as a strip, the leading end of a new roll material 42 is joined to said trailing end, thereby continuing the feeding-out. Therefore, the sections-for-discarding 92a, 92b are merely a vicinity of a trailing end of the preceding roll material 42 (the first strip 80) and a vicinity of a leading end of the new roll material 42 (the second strip 82). That is, a discarded amount of the roll material 42 is greatly reduced, so a lowering of material costs of the element 10 can be achieved.

Moreover, since it is only required that the new roll material 42 is fed out to the strip joining apparatus 48 and since this work takes only a comparatively short time, arrangements for setting the new roll material 42 in the feeder 50, and so on, are unnecessary. That is, the case of joining as described above excels in work efficiency. Therefore, it is possible to achieve even greater lowering of manufacturing costs of the element 10.

The present invention is not particularly limited to the above-described embodiment, and may undergo a variety of modifications in a range not departing from the spirit of the present invention.

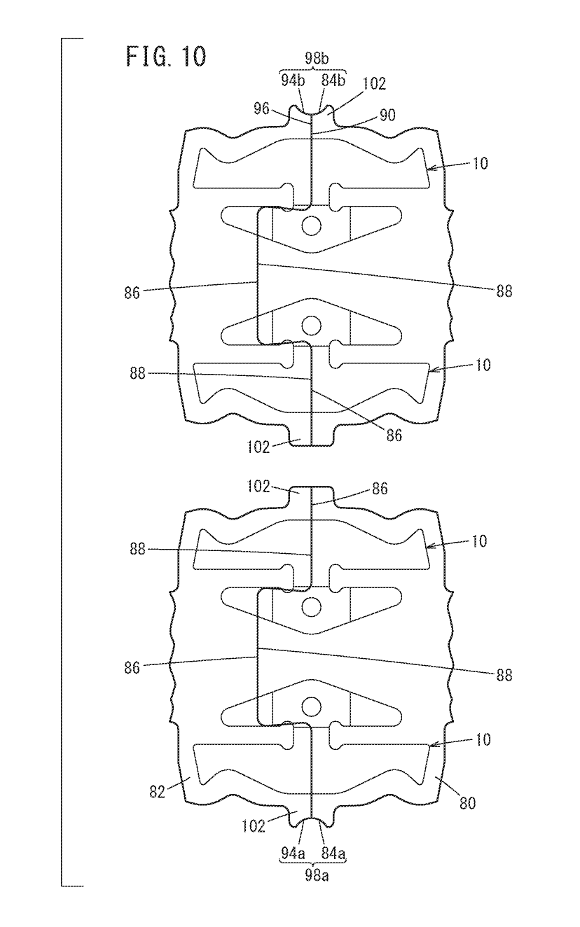

For example, when a sufficient caulking force is obtained, a configuration may be adopted whereby as shown in FIG. 10, the first recessing-and-projecting line 90 and the second recessing-and-projecting line 96 are formed such that either one of the recess 86 or the projection 88 alone exists in one item of the element 10.

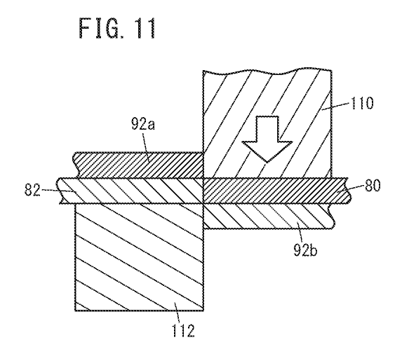

Moreover, a configuration may be adopted whereby as shown in FIG. 11, a laminated section is formed by laminating the vicinity of the leading end of the second strip 82 as a lower side and the vicinity of the trailing end of the first strip 80 as an upper side, and a shearing processing is performed on said laminated section. In this case, the vicinity of the trailing end of the first strip 80 that has been positioned on the upper side is sheared so as to descend along with processing of a punch 110, and when it attains the same height as the vicinity of the leading end of the second strip 82 that has been placed on a die 112, is joined to said vicinity of the leading end. The vicinity of the leading end of the second strip 82 that has been sheared along with processing of the punch 110 becomes the section-for-discarding 92b, and the vicinity of the trailing end of the first strip 80 that has been left on the die 112 becomes the section-for-discarding 92a. At the same time, the first recessing-and-projecting line 90 and the second recessing-and-projecting line 96 are respectively formed in the first strip 80 and the second strip 82, and these first recessing-and-projecting line 90 and second recessing-and-projecting line 96 are fitted to each other and caulked.

What is claimed is:

1. A method of joining belt materials comprising:
a joining step in which a trailing end of a first belt material which is fed out ahead and a leading end of a second belt material which is fed out after the first belt material, are opposed, and a first recessing-and-projecting line is formed in the trailing end of the first belt material while a second recessing-and-projecting line is formed in the leading end of the second belt material, and then the first recessing-and-projecting line and the second recessing-and-projecting line are fitted to each other thereby joining the first belt material and the second belt material; and
a punching step in which the first belt material and the second belt material are fed out and punched in a shape of an element of a belt for continuously variable transmission,
in the joining step, the first recessing-and-projecting line and the second recessing-and-projecting line being formed in a position that passes through a holding section holding the element in the first belt material or the second belt material, thereby joining the first belt material and the second belt material.

2. The method of joining belt materials according to claim 1, wherein the first recessing-and-projecting line and the second recessing-and-projecting line include at least one pair of a recess and a projection within one item of the element.

3. The method of joining belt materials according to claim 1, wherein notches are formed in a vicinity of the trailing end of the first belt material, and the first recessing-and-projecting line is formed in a state where engaging members have been engaged in the notches.

4. The method of joining belt materials according to claim 1, wherein notches are formed in a vicinity of the leading end of the second belt material, and the second recessing-and-projecting line is formed in a state where engaging members have been engaged in the notches.

5. The method of joining belt materials according to claim 1, wherein first notches are formed in a vicinity of the trailing end of the first belt material and second notches are formed in a vicinity of the leading end of the second belt material, and the first recessing-and-projecting line and the second recessing-and-projecting line are fitted to each other in a state where engaging members have been engaged in composite notches formed by parts of the first notches and parts of the second notches.

6. The method of joining belt materials according to claim 1, wherein after the first recessing-and-projecting line and the second recessing-and-projecting line have been fitted to each other, bodies of recesses and projections forming the first recessing-and-projecting line and recesses and projections forming the second recessing-and-projecting line are stretched by crushing.
